(19) United States
(12) Patent Application Publication
(10) Pub. No.: US 2009/0019472 A1
(43) Pub. Date: Jan. 15, 2009

(54) Systems and methods for pricing advertising

(76) Inventors: Todd A. Cleland, Corvallis, OR (US); Darryl Greig, Bristol (GB)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/827,422

(22) Filed: Jul. 9, 2007

(51) Int. Cl. H04N 7/10

(52) U.S. Cl. 725/34

(57) ABSTRACT

A system for pricing advertising includes an electronic video display disposed in an advertising venue, wherein the display is configured to display advertising; a sensor configured to sense a number of people in an audience of the electronic video display; and a processing element for determining pricing for the advertising. The pricing for the advertising is determined based on the number of people in the audience. A method of pricing advertising, the method includes determining a number of people in an audience of an electronic video display disposed at an advertising venue on which the advertising is displayed; and determining pricing of the advertising based on the number of people in the audience.

### BACKGROUND

Advertisers are constantly looking for opportunities to present information about their products to customers and potential customers. For example, advertising is provided on television, in magazines and newspapers, on web-sites, on roadside billboards, at sporting and other events, by mail, on moving vehicles, etc.

Typically, the wider an audience that a given advertising medium is expected to reach, the more it will cost the advertiser to place advertising in that medium. For example, on television, surveys are conducted to determine the number of viewers any particular television show attracts. Advertisers are then charged to have their advertising and commercials shown in connection with that television program based on that assessment of audience size. The larger the audience, the more expensive it will be to advertise during, or as a sponsor of, that television program.

Similarly, on the Internet, advertisers may be charged based on the traffic a host can generate to the advertiser's materials. For example, the advertiser may be charged based on the number of hits to a host web-site where advertising is posted. Alternatively, the advertiser may be charged based on the number of times a browser links to the advertiser's materials from a host web page.

Clearly, the more viewers an advertising medium can obtain, the greater the value to an advertiser of placing advertising in that medium. Consequently, the advertiser will be willing to pay, and will likely be charged, based on the popularity of the advertising medium in question.

### BRIEF DESCRIPTION OF THE DRAWINGS

The accompanying drawings illustrate various embodiments of the principles described herein and are a part of the specification. The illustrated embodiments are merely examples and do not limit the scope of the claims.

FIG. 1 is a block diagram of an exemplary system of determining pricing for advertising, according to principles described herein.

FIG. 2 is a block diagram of an exemplary system of determining pricing for advertising, according to principles described herein.

FIG. 3 is an illustration of an exemplary system for determining pricing for advertising, according to principles described herein.

FIG. 4 is an illustration of an exemplary system for determining pricing for advertising, according to principles described herein.

FIG. 5 is an illustration of an exemplary system for determining pricing for advertising, according to principles described herein.

FIG. 6 is a flowchart illustrating an exemplary method of determining pricing for advertising, according to principles described herein.

FIG. 7 is a flowchart illustrating an exemplary method of determining pricing for advertising, according to principles described herein.

Throughout the drawings, identical reference numbers designate similar, but not necessarily identical, elements.

### DETAILED DESCRIPTION

Electronic video displays for providing advertising are placed in a wide variety of venues. For example, such displays are commonly found in retail stores, airports, shopping malls, train and bus stations, at sporting events, in movie theaters, in convention halls, in hotels, as roadside signs, on buildings, in waiting rooms, etc. Electronic video displays showing advertising are also found in airplanes, on trains and subways, and other transit systems. As used herein and in the appended claims, the term “advertising venue” will refer to these and any other location where an electronic video display for advertising may be placed.

Any of a wide variety of devices can be used as the electronic video display for displaying advertising described herein. For example, large and small scale liquid crystal displays are frequently used as electronic video displays for displaying advertising. However, an electronic video display may also be a cathode ray tube (CRT) display, a light-emitting diode (LED) display, a plasma screen device or any other television, monitor or display device on which advertising can be displayed. As used herein and in the appended claims, the term “electronic video display” will refer to these and any other devices for visually displaying advertising or advertising materials to an audience, with or without accompanying audio.

As used herein and in the appended claims, the term “advertising,” “advertisement” or “advertising materials” will be used broadly to describe any visual content, whether motion picture video, a still image or a series of still images, with or without accompanying audio, that is displayed to promote sales of goods or services or to influence purchases or opinions on behalf of an advertiser.

As used in the present specification and in the appended claims, the term “user interface device” refers to an electronic apparatus configured to interact with a central processing element. Devices thus defined may receive power and/or communicate with the central processing element through a wired or a wireless connection. Examples of user interface devices include, but are not limited to, keyboards, kiosks, wired devices provided in conjunction with a public display, touch-screen devices and personal electronic devices, as further defined below.

As used in the present specification and in the appended claims, the term “personal electronic device” refers to an electronic apparatus configured to interact with a central processing element such as a server or a supporting wireless network. Personal electronic devices thus defined may be handheld, battery-powered and may communicate wirelessly with the central processing element through a wireless network. Examples of personal electronic devices include, but are not limited to, personal digital assistants (PDAs), portable computers, mobile and cellular phones, and custom devices.

As noted above, many types of advertising media have developed a mechanism for assessing how effecting that particular advertising medium is. This is typically measured by determining the number of people, customers or potential customers, who could be exposed to the advertising presented in that medium. As also noted above, the wider the audience an advertising medium can attract and document, the more that advertising medium can charge for its services. For some advertising media, advertising effectiveness can also be quantified by measuring a number of actual responses by customers or potential customers to the advertising in addition to merely quantifying the number of customers or potential customers exposed to the advertising.

Advertising on electronic video displays is traditionally priced on a CPM (cost per thousand impressions) basis, just like mass market media such as television, radio and newspapers. Advertisers traditionally pay a set amount based on the number of people who may potentially see the advertisement. The present specification describes a system and method for using automatic audience measurement technology and interactivity data to determine pricing for advertising on electronic video displays. Consequently, advertising can be priced more effectively by being based on the actual number of people who see the advertising or come within close proximity to it. In some examples, the advertising pricing can also be based on a number of actual responses to the advertising. Consequently, advertisers can justify paying higher rates for advertising that is demonstrated to be effective and will not have to pay for ineffective messaging. As a result, the operators of electronic video displays will receive enhanced revenues for advertising that can be demonstrated to be effective.

In the following description, for purposes of explanation, numerous specific details are set forth in order to provide a thorough understanding of the present systems and methods. It will be apparent, however, to one skilled in the art that the present apparatus, systems and methods may be practiced without these specific details. Reference in the specification to “an embodiment,” “an example” or similar language means that a particular feature, structure, or characteristic described in connection with the embodiment or example is included in at least that one embodiment, but not necessarily in other embodiments. The various instances of the phrase “in one embodiment” or similar phrases in various places in the specification are not necessarily all referring to the same embodiment.

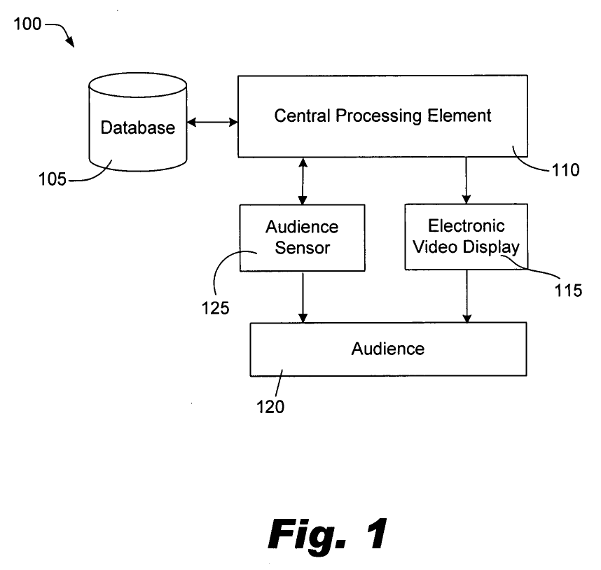

FIG. 1 is a diagram of an exemplary system for determining pricing for advertising based on the size of the audience in the immediate area. In various examples, the system (100) may be placed in a public area such as a mall, shopping center, city plaza, museum, or other public area having a significant amount of pedestrian traffic. The exemplary system (100) includes a central processing element (110) with access to a database (105) configured to store advertising content and other information. The central processing element (110) is in communication with and controls an electronic video display (115) and an audience sensor (125) which are located at or in an advertising venue.

As noted above, the advertising venue can be any location where people might be and can be exposed to advertising. For example, the advertising venue may be a place of business, an airport, a train or bus station, a shopping mall, a waiting room, a sporting event, a convention or meeting hall, a hotel, a sporting or other event or a roadside sign.

The electronic video display (115) may be, for example, any display device capable of displaying advertising or advertising materials, with or without accompanying audio. In some examples, the electronic video display (115) is a large-scale liquid crystal display device or monitor.

As also shown in FIG. 1, the system (100) includes a sensor (125). The sensor (125) may be any sensor that helps determine the size of the audience (120) at the electronic video display (115). For example, the sensor (125) may be an infrared sensor that counts the audience based on body heat patterns. Alternatively, the sensor (125) may be an optical camera for imaging the audience or a pressure-sensing floor mat.

The sensor (125) may be configured to measure the audience (120) in that area in which the audience (120) is likely to congregate and from which the audience (120) will be able to view the electronic video display (115). As shown in FIG. 1, the data from the sensor (125) is output to a central processing element (110). The sensor (125) may communicate with the central processing element (110) by a wired or wireless connection.

The central processing element (110) is configured to receive data from the sensor (125) and evaluate the data in order to determine the number of people in the audience (120). The central processing element (110) may be selected from the group including: computers, servers, application specific integrated circuits, other processors, and the like. In the illustrated example, the central processing element (110) then time stamps the determination of the audience size and stores it in the database (105) along with a time stamped advertisement play list. The central processing element (110) will then match the measured audience size with the advertising displayed to that measured audience using the time stamped audience size measurements as compared to the time stamped advertisement play list. With both sets of data being time stamped, the results or effectiveness of each piece of advertising can be easily aggregated and determined.

The audience size for each piece of advertising may then be used to determine the price the advertiser must pay for that advertising. Specifically, the advertiser can be charged and will pay more as the size of the measured audience increases. For example, the advertiser may pay a set base fee for having the advertising displayed and then an additional fee based on, or corresponding to, the size of the measured audience. For example, the fee for displaying the advertising could be calculated as follows:

Fee=Base Fee+(Audience Size×CPM)

where the Base Fee is based on gross venue traffic and may be similar to advertising pricing in other media without audience feedback; and

where CPM is a charge per thousand impressions, i.e., an amount charged for each thousand people in the audience who could or may have been exposed to the advertising.

In some examples, there may also be a cap or maximum Fee, such as a “not to exceed” amount so that advertisers can budget their advertising spending in advanced. The model may be time based, i.e., the advertising runs for a set amount of time, or may be exposure based, i.e., the advertising runs until a predetermined number of impressions or viewer interactions are achieved.

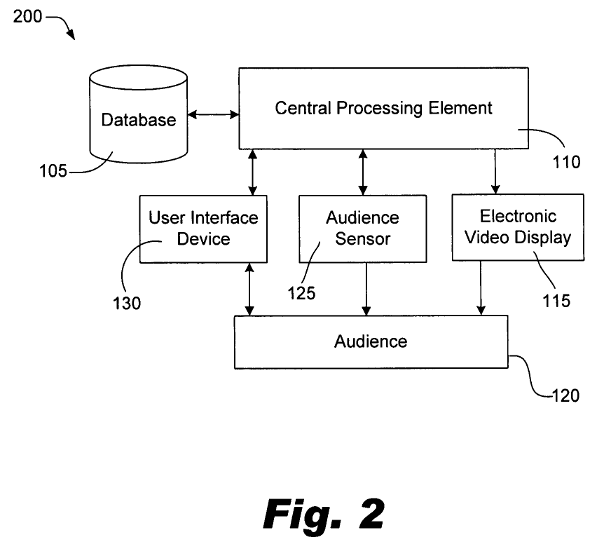

Referring now to FIG. 2, another diagram of an exemplary system (200) for determining the price of advertising on an electronic video display (115) is shown. This exemplary configuration includes all of the elements of the configuration in FIG. 1 with the addition of a user interface (130). The user interface (130) is a device configured to allow the user to interact with the central processing element (110) and obtain additional information about the advertisements or advertised products. In one example, the user interface (130) may be a kiosk that incorporates or is situated near the electronic video display (115). In another example, the user interface (130) may be a touch-sensitive screen of the electronic video display (115). In another example, the user interface (130) may be a personal electronic device, such as a mobile phone, for example, that the user may use to communicate with the central processing element (110), for example, by sending a text message, email message or placing a telephone call.

As will be appreciated by those skilled in the art, there are a great many methods and ways in which a user could interact with the central processing element (110) through the use of a user interface (130). All such methods and uses are within the scope of the present specification. All of the users' interactions with the central processing element (110) regarding an advertisement may also be time stamped and stored in the database (105). Consequently, in addition to the factors described above, such as measured audience size, the price the advertiser pays for the advertising may also reflect the number of interactions users initiated regarding the advertisement. In such examples, the fee charged to the advertiser may be calculated as follows.

Fee=Base Fee+(Audience Size×CPM₁)+(User Interactions×CPMₛ)

where CPM is a charge per thousand impressions, i.e., CPM₁ is an amount charged for each thousand people in the audience who could or may have been exposed to the advertising, and CPM₂ is an amount charged for each unit of user interactions, e.g., each thousand interactions, received in response to the advertising through the user interface device (130). In some examples, the “Base Fee” may be removed from the equation. Again, in some examples, the total Fee may be capped at a not-to-exceed maximum.

In other examples, the price charged to the advertiser may be based only on the number of interactions received from users through the user interface device (130) irrespective of the number of people in the audience (120). In such examples, either or both of the “Audience Size” and the “Base Fee” factors may be removed from the equation.

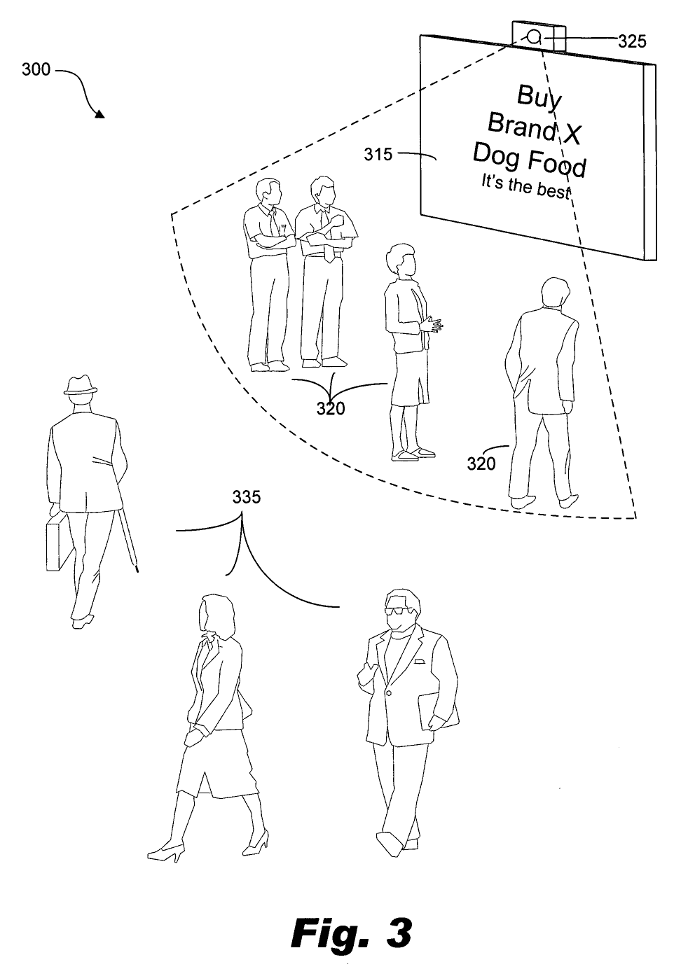

FIG. 3 illustrates an exemplary system (300) according to principles described herein for determining the pricing for advertising on an electronic video display (315). As shown in FIG. 3, an electronic video display (315) is provided at or in an advertising venue. As noted above, the advertising venue can be any location where people might be and can be exposed to advertising. As shown in FIG. 3, an audience (320) of people will tend to view the electronic video display (315). In some examples, the number of people in the audience (320) may be in constant fluctuation as people come and go from the advertising venue. In other examples, the number of people in the audience (320) may be fairly constant for a period of time depending on the nature of the advertising venue.

As also shown in FIG. 3, the system (300) includes a sensor (325). In the example illustrated in FIG. 3, the sensor (325) is an optical camera, for example, a charge coupled device (CCD). Depending on the size of the audience area, the camera (325) may be a wide angle camera. In other examples, the camera (325) may be in motion, panning over the area where the audience (320) is likely to congregate, so as to cover a wider audience area. In still other examples, the camera (325) may be embodied as a number of cameras aimed at different portions of an audience area so as to adequately monitor the entire audience area.

The image from the camera or other sensor (325) can be used to identify the number of people in the audience (320). In the case of an optical camera, this may be done based on facial recognition. Each person in the audience (320) has a face. While distinguishing electronically between two different human faces is a non-trivial task to which a great amount of work has been dedicated, for audience counting purposes, it is only necessary to distinguish each face from other objects in the image taken by the camera (325).

As indicated above, the central processing element (110, FIGS. 1, 2) may process an image signal from an optical camera (325) and identify within the image or images received the instance of each human face in the audience (320). This can be done based on feature recognition of the basic features of a human face without the need for the resolution that would distinguish one human face from another. See, for example, U.S. Pat. Nos. 7,099,510; 6,556,989; 5,966,696; 5,923,252; 5,642,484 and 6,958,710; and U.S. Patent App. Pub. Nos. 2002-0077891, 2005-0198661 and 2006-0287913, all of which are incorporated by reference herein in their respective entireties.

Alternatively, the sensor (325) may be a motion sensor, an infrared or heat sensor or another other type of sensor that will allow for a count of the number of people in the audience (320) to be reliably generated. In some examples, ceiling-mounted cameras (infrared or visual spectrum) may be used for traffic counting.

Once the central processing element (110, FIGS. 1, 2) has made a determination of the number of people in the audience (320), that information may be time stamped and stored in the database (105, FIGS. 1, 2) and used at a later time for determining the amount to charge an advertiser.

The camera or sensor may additionally be able to track individual faces by comparing the faces in consecutive frames (using, for example, size, location, motion vectors, facial features and other summary features) and thus monitor the total audience size at any given moment. Additionally, the sensor may be able to detect the orientation of the faces. Specifically, the sensor may be able to detect when a face is oriented directly toward the electronic video display (315), thus the length of time that each face is directed at the display (315) could be monitored. In other words, the central processing element (110, FIGS. 1, 2) may be configured to determine whether and for how long human faces in the images from a camera or sensor are attentive to the electronic video display. The advertiser could then be charged for the advertisement through the use of a variable pricing scheme with higher pricing for longer gaze durations.

This information may also be used to determine the type of content to be displayed. For example, if nobody in the audience (320) is looking at the display, content intended to capture people's attention could be displayed. In addition, the central processing element (110, FIGS. 1, 2) may be able to determine additional information from the faces such as facial expressions, race, age or gender. In such examples, this information may be used to adaptively program the advertising displayed to better suit the predominant characteristics of the audience, such as age or gender.

The information about the audience may be time stamped and stored in the database (105, FIGS. 1, 2). As described above, the information about the audience is matched to, or compared with, a time stamped an advertising content play list.

In some examples, advertisers may be charged an additional amount for access to the audience data which may then be used to evaluate the effectiveness of the advertising content as compared with a target demographic. The information in the database (105, FIGS. 1, 2) may, for example, inform advertisers when they were losing significant numbers of viewers, or which parts of an advertisement attracted the most viewers.

As is illustrated in FIG. 3, there may be additional potential observers (335) at the venue who see the advertisement on the electronic video display (315) but who are too far away from the sensor (325) to be counted or considered part of the audience (320). These potential observers (335) may look at the display (315) while walking past, or may choose to ignore the advertisement. In order to account for these potential observers (335) in the pricing structure, the pricing for the advertisement may include a base rate, as described above, based on the gross traffic at a venue. The gross traffic at a venue may be estimated by infrequent traffic surveys which give an estimate of the number of people in a period of time that will have the opportunity to see a particular advertisement on an electronic video display (325). Additional fees may be added to this base rate based on the number of measured audience members (320), and the number of interactions users initiated via a user interface (130, FIG. 2) with respect to a particular advertisement.

In other examples, the base rate may be adjusted based on the time of day. For example, some venues may have high traffic at specific times of day during which the base rate for advertising in that venue would be higher than at other times for the same location.

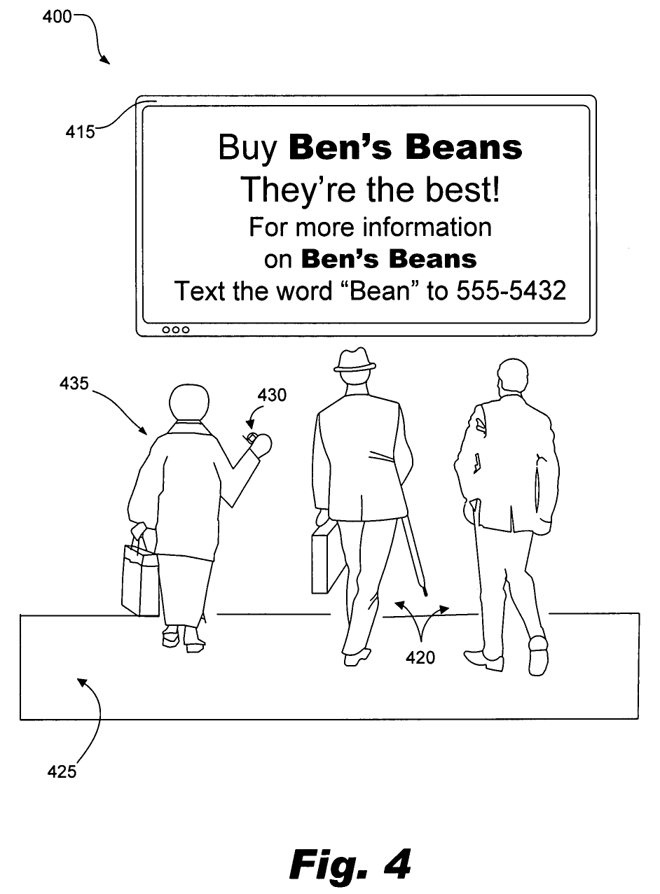

Referring now to FIG. 4, an exemplary system (400) is shown for determining pricing for advertising based on audience size and interactions. Consistent with the diagram of FIG. 2 described above, this system (400) includes an electronic video display (415), an audience sensor (425), and is configured to allow users to use a user interface (430) to interact with the central processing element (110, FIGS. 1, 2).

The sensor (425) shown in FIG. 4 is a pressure sensing surface or floor (425) located in the area where the audience is likely to congregate. The sensor (425) may consist of one or more sensing elements disposed on the underside of one or more tiles, plates or mats. This sensor (425) may be configured to react to a mechanical force such as pressure. The sensor (425) may be configured to send a signal to the central processing element (110, FIGS. 1, 2) indicating the presence or number of people standing on the floor near the electronic video display (415). The central processing element (110, FIGS. 1, 2) may record this information in the database (105, FIGS. 1, 2) for use in calculating the pricing for the advertisement being displayed.

The sensor (425) may resolve individuals in the audience in a number of ways. For example, the sensor (425) may determine the number of individuals in the audience based on separate locations where pressure is detected. In other examples, the sensor (425) may determine the approximate number of individuals in the audience based on the weight or pressure corresponding to an average person.

An electronic video display (415) is also shown. In the illustrated example, the electronic video display (415) is shown displaying an advertisement that invites the audience (420, 435) to send a text message to a particular number. One of the observers (435) is shown interacting with the central processing element (110, FIGS. 1, 2) through the use of a personal electronic device (430). The central processing element (110, FIGS. 1, 2) may send the observer (435) further information about the advertisement and then store a record of the interaction in the database (105, FIGS. 1, 2) as discussed above.

The information stored in the database (105, FIGS. 1, 2) regarding the audience size and the interactions with the audience (435, 420) may then be used in conjunction with a base rate to determine the price to bill the advertiser for the display of the advertisement as will be discussed in more detail below.

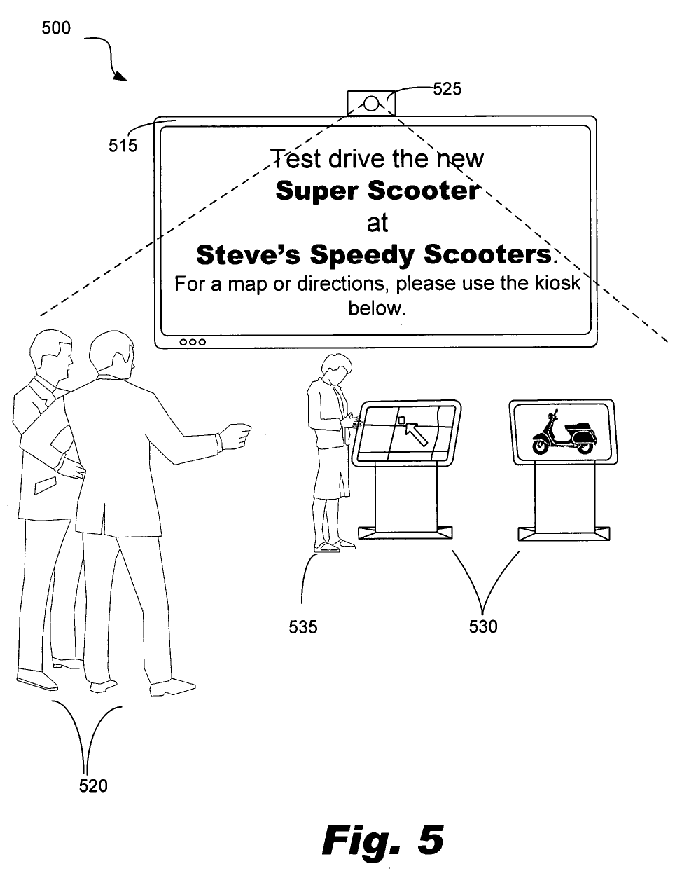

Referring now to FIG. 5, an exemplary system (500) is shown for determining pricing for advertising based on audience size and interactions. Consistent with the diagram of FIG. 2 described above, this system (500) includes an electronic video display (515), an audience sensor (525), and a plurality of user interfaces (530).

An audience sensor (525) is shown situated above the electronic video display (515). This sensor (525) may be, for example, an optical camera, as described above, or an infrared sensor that counts the audience (520, 535) based on body heat patterns. In some embodiments, the sensor (525) may include a number of infrared sensors aimed at different portions of an audience area so as to adequately monitor the entire audience area. As in other embodiments described above, the data that the sensor (525) collects may be sent to the central processing element (110, FIGS. 1, 2) for storage in the database (105, FIGS. 1, 2) and use in calculating the pricing of the advertisements.

Also shown in FIG. 5 are exemplary user interfaces (530). In the illustrated example of the system (500), the user interfaces (530) are touch-screen devices or kiosks that an observer (535) may use to obtain more information about an advertisement. The user interfaces (530) in this embodiment are configured to interact directly with the central processing element (110, FIGS. 1, 2) to provide the user with the information available. The central processing element (110, FIGS. 1, 2) may also record the number and type of the interactions initiated with the user interfaces (530). As described above, the price charged the advertiser for displaying the advertising may be based, at least in part, on the quantity of such interactions received from the user interfaces (530).

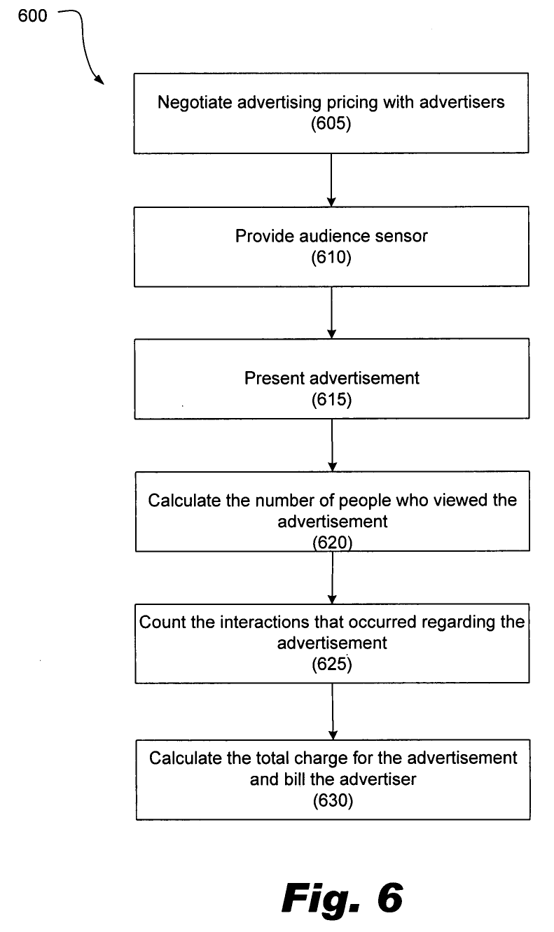

FIG. 6 is a flowchart illustrating an exemplary method (600) of computing the fee charged to an advertiser for display of an advertisement or advertising. As shown in FIG. 6, the method (600) begins when an advertiser decides to negotiate (step 605) a pricing structure for advertising time on the electronic video display. The negotiated pricing structure may be based on the size of the audience as determined by the sensors, the number of interactions that audience members initiate through the user interfaces, the gross venue traffic, or any combination thereof.

The method (600) further includes providing (step 610) an audience sensor. As the advertisement is presented (step 615) on the video display, the size of the audience is calculated (step 620) by the audience sensor. The number of interactions that audience members initiated with a user interface may also be determined (step 625). The total price for the advertisement may then be calculated (step 630) according to the negotiated pricing structure.

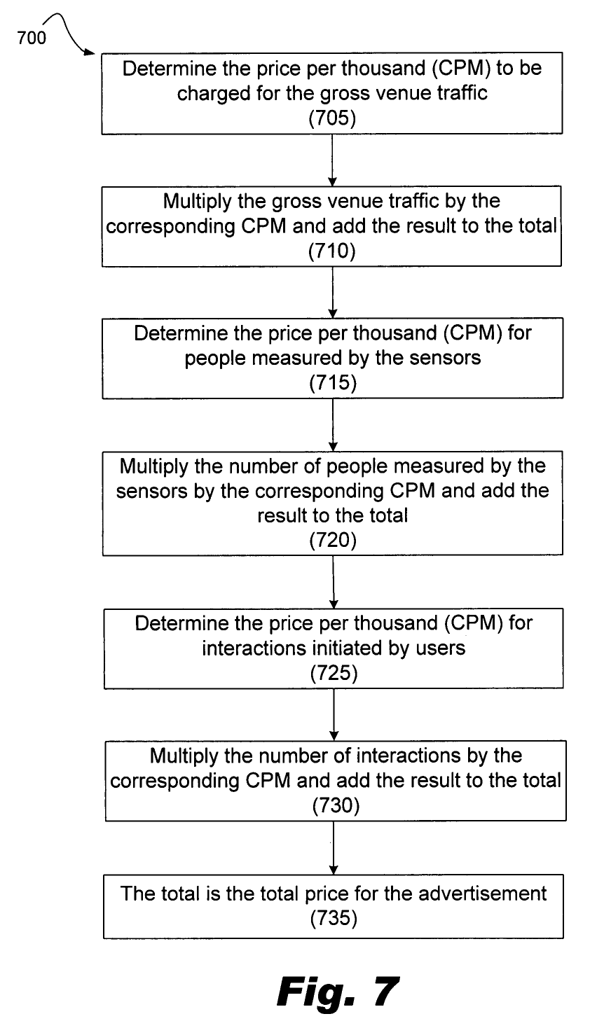

FIG. 7 is a flowchart illustrating an exemplary method (700) of determining the price for an advertisement according to an exemplary pricing structure. The method begins by determining (step 705) a price per thousand impressions (CPM) that the advertiser will pay based on the gross venue traffic. The gross traffic at a venue may be estimated by infrequent traffic surveys which give an estimate of the number of people in a period of time that will have the opportunity to see a particular advertisement on an electronic video display. As noted above, this gross traffic estimate may depend on time of day. This CPM accounts for people who may see an advertisement but to not approach closely enough to be counted by the audience sensor. This CPM is multiplied (step 710) by the gross venue traffic and the result is added to a running total.

The CPM that the advertiser will pay for people actually measured by the sensors as part of the advertising audience and the CPM that the advertiser will pay for interactions initiated by users are also determined (steps 715, 725). These CPMs are multiplied by the number of people measured by the sensors and the number of user interactions received, respectively, and the results are added (steps 720, 730) to the total. The total now represents the total cost that will be charged to the advertiser (step 735).

As noted above, any of steps 710, 720 or 730 may be omitted from an exemplary method according to the principles described herein. In other words, the negotiated pricing structure may be based on the size of the audience as determined by the sensors, the number of interactions that audience members initiate through the user interfaces, the gross venue traffic, or any combination thereof.

The preceding description has been presented only to illustrate and describe embodiments and examples of the principles described. This description is not intended to be exhaustive or to limit these principles to any precise form disclosed. Many modifications and variations are possible in light of the above teaching.

What is claimed is:

1. A system for pricing advertising, said system comprising:
an electronic video display disposed in an advertising venue, wherein said display is configured to display advertising;
a sensor configured to sense a number of people in an audience of said electronic video display; and
a processing element for determining pricing for said advertising;
wherein said pricing for said advertising is determined based on said number of people in said audience.

2. The system of claim 1, wherein said sensor comprises an optical camera.

3. The system of claim 2, further comprising an evaluation program configured to determine a number of human faces in images output by said optical camera.

4. The system of claim 3, wherein said evaluation program is further configured to determine whether and for how long human faces in said images are attentive to said electronic video display.

5. The system of claim 1, wherein said sensor comprises an infrared camera.

6. The system of claim 1, wherein said sensor comprise a pressure sensing floor.

7. The system of claim 1, further comprising an advertising database storing advertising materials to be displayed on said electronic video display and information regarding said number of people in said audience;
wherein said pricing for said advertising is also based on whether said information regarding said audience is provided to an advertiser.

8. The system of claim 1, further comprising one or more user interfaces, wherein said pricing for said advertising is further based on user interactions with said user interfaces.

9. The system of claim 1, wherein said pricing for said advertising is further based on an estimate of gross traffic in said venue.

10. The system of claim 9, wherein said estimate of gross traffic varies depending on time of day.

11. A method of pricing advertising, said method comprising:
determining a number of people in an audience of an electronic video display disposed at an advertising venue on which said advertising is displayed; and
determining pricing of said advertising based on said number of people in said audience.

12. The method of claim 11, wherein determining said number of people further comprises determining a number of human faces in an image output by an optical camera.

13. The method of claim 11, wherein determining said number of people further comprises counting the number of human body heat patterns in said audience.

14. The method of claim 11, wherein determining said number of people further comprising receiving output from pressure sensors in a floor adjacent said electronic video display.

15. The method of claim 11, further comprising receiving user interactions from members of said audience through a user interface, wherein said pricing of said advertising is further determined by a number of interactions users initiate with said user interface.

16. The method of claim 15, wherein said user interface comprises a personal electronic device.

17. The method of claim 11, wherein the pricing of said advertising is further determined based on an estimate of gross venue traffic.

18. The method of claim 17, wherein said estimate of gross venue traffic varies depending on a time of day.

19. A system of providing advertising comprising:
an electronic video display at an advertising venue;
means for determining a number of people in an audience of said electronic video display; and
means for determining a price for an advertisement displayed on said electronic video display based on at least one of (1) said number of people determined to be present at said electronic video display, (2) a number of user interactions received through a user interface in response to said advertisement and (3) an estimate of gross venue traffic.
